(19) United States
(12) Patent Application Publication
(10) Pub. No.: US 2003/0188939 A1
(43) Pub. Date: Oct. 9, 2003

(54) Hydraulic vehicle braking system

(76) Inventors: Mark M. Schneider, Royal Oak, MI (US); Larry W. Bowman, Troy, MI (US); Paul R. Sieber, Rochester Hills, MI (US); Robert W. Hildebrand, Rochester Hills, MI (US); Michael E. Johnson, Rochester, MI (US); James R. Brichta, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/119,266

(22) Filed: Apr. 9, 2002

(51) Int. Cl. F16D 57/02

(52) U.S. Cl. 188/296

(57) ABSTRACT

A hydraulic vehicle braking system includes a housing that contains a hydraulic fluid. A braking application includes using the hydraulic fluid to provide a braking force. In one example, increasing the pressure within the housing increases the braking force. One example includes a plurality of vanes that move within the hydraulic fluid. Changing an orientation of the vanes adjusts the resistance and the amount of braking force. Increased pressure and increased resistance to the movement of the vanes within the fluid causes a braking member and associated driveline components to slow down to achieve a desired deceleration of the vehicle. In one example, a fluid accumulator is associated with the housing to receive at least some of the hydraulic fluid during a braking application. The accumulator preferably is pressurized using a gas that facilitates returning the hydraulic fluid to the brake housing after a braking application has ended.

### BACKGROUND OF THE INVENTION

This invention generally relates to vehicle braking systems. More particularly, this invention relates to a hydraulically powered arrangement for supplying a braking force to decelerate a vehicle.

Vehicle braking systems come in many forms, depending on the particular vehicle and the needs during the expected service life of the vehicle.

A variety of vehicles are manufactured for a variety of purposes. Examples include passenger vehicles, heavy vehicles such as trucks, and off highway vehicles. Each type of vehicle has particular component requirements to meet the needs of the typical situation in which the vehicle is placed during use. Accordingly, a variety of vehicle components have been developed, each having its own benefits and, in some cases, shortcomings or drawbacks.

In off-highway type vehicles, for example, oil in the brake and axle assemblies tends to heat up during braking applications. In many cases, especially in the case of liquid cooled wet disc brakes, the generated heat exceeds that which can be dissipated by the axle assembly or brake assembly using normal passive methods.

The heat build up must be dissipated to maximize component life and performance. The fatigue performance of components such as gears decreases with incremental rises in temperature. Vehicle manufacturers and suppliers have been forced to design complex and often undesirably costly cooling systems in an attempt to regulate the temperature within the components resulting from braking applications. Alternative approaches or techniques are needed.

This invention provides an energy-efficient braking system that reduces the difficulties of such heat management issues.

### SUMMARY OF THE INVENTION

In general terms, this invention is a hydraulic vehicle braking system.

A system designed according to this invention includes a housing. A fluid is contained at least partially within the housing. A braking member has a plurality of vanes oriented to extend into the fluid containing portion of the housing. The vanes selectively move within the housing such that the vanes cause an increased pressure within the housing to provide a braking force during a braking application.

In one example, the vanes are supported on a braking member that includes a disc portion that rotates with a corresponding vehicle driveline component such as an axle shaft or a wheel. The disc portion supports disc brake material that is positioned to engage a corresponding braking surface of the housing to provide a braking force in addition to that provided by the vanes interacting with the hydraulic fluid within the housing.

In one example, an accumulator is in fluid communication with the housing so that some of the braking fluid can be transferred to the accumulator responsive to increased pressure within the housing. The accumulator may be pressurized with a gas such that the gas operates to return at least some of the fluid to the housing after a braking application has ended. In one example, the accumulator includes external fins that facilitate dissipating heat from the fluid that is transferred from the housing to the accumulator.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a system designed according to this invention.

FIG. 2 schematically illustrates, in somewhat more detail, selected portions of the embodiment of FIG. 1.

FIG. 3 schematically illustrates an example braking member designed according to an embodiment of this invention.

FIG. 4 illustrates an alternative braking member design.

### DETAILED DESCRIPTION OF THE PREFERRED EMBODIMENTS

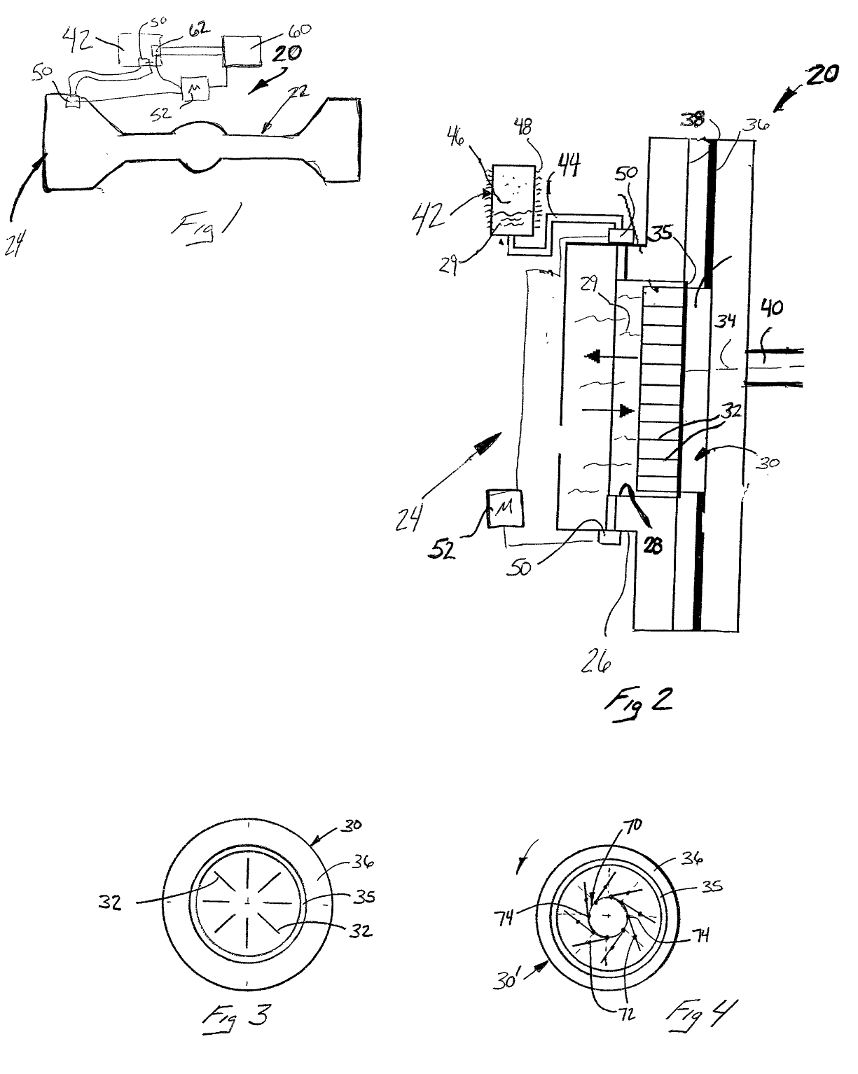

FIG. 1 schematically illustrates selected portions of a vehicle driveline 20 including a driveline component housing 22. The illustrated example includes a combined axle and brake housing 22 that houses an axle shaft and brake components associated with the axle shaft to cause deceleration of the vehicle wheels as needed. Such arrangements on off-highway type vehicles are generally well-known so that a detailed explanation of all the internal components is not given in this description. A brake housing portion 24 supports braking components designed according to this invention.

As best appreciated from FIG. 2, the braking portion of the driveline assembly includes a housing 26 having a fluid containing portion 28. The housing 26 may be formed as part of the housing portion 24 or as a separate component. A hydraulic fluid 29 preferably is disposed within the fluid containing portion 28. A braking member 30 interacts with the fluid 29 to cause an increased fluid pressure within the fluid containing portion 28 of the housing 26. The increased pressure causes additional resistance within the system, which provides a braking force.

The illustrated example includes a plurality of vanes 32 supported on the braking member 30. As the braking member 30 and the vanes 32 rotate about an axis 34, there is resistance because of the interaction between the vanes 32 and the fluid 29. A seal 35 preferably facilitates allowing the vanes 32 to rotate within the fluid containing portion 28 of the housing 26 while maintaining the fluid 29 within the desired portion of the housing. The seal 35 prevents interaction between the hydraulic fluid 29 and oil contained within other portions of the axle housing, for example.

During a braking application, the braking member 30 moves along the axis 34 so that the vanes 32 protrude further into the fluid containing portion 28 of the housing 26. Such movement is responsive to a driver applying pressure to a brake pedal. In one example, the seal 35 moves with the braking member 30 so that the decreased volume of the fluid containing portion causes an increased pressure within the fluid containing portion 28. The increased pressure causes increased resistance to the rotation of the vanes 32 about the axis 34, which provides a braking force to slow down rotation of the braking member. By appropriately associating the braking member 30 with another portion of the driveline, such as an axle shaft or a wheel, the desired vehicle deceleration is made possible because the braking member 30 shows down.

The illustrated example includes a disc portion 36 associated with the braking member 30. The disc portion 36 preferably interacts with a braking surface 38 supported by the housing 26 after a sufficient axial movement of the braking member 30. The disc portion 36 and braking surface 38 preferably are made from materials used in wet disc assemblies so that they operate as a wet disc assembly. Wet disc brake assemblies and suitable materials for such an arrangement are known in the art. The disc portion 36 and the braking surface 38 provide a supplemental braking force provided by the hydraulic portion.

The use of the fluid pressure build up and resistance associated with the interaction between the vanes 32 and the hydraulic fluid 29 reduces the amount of heat build up during a braking application as occurs in conventional wet disc brake arrangements. The braking force provided by the hydraulic arrangement, therefore, provides a more energy-controlled system.

A further enhancement for controlling energy within the system includes providing an accumulator 42 that is fluidly coupled with the fluid containing portion 28 of the housing 26. A conduit 44 is included in the illustrated example to allow fluid communication between the housing portion 28 and the accumulator 42.

The accumulator 42 preferably is pressurized using a gas 46, such as nitrogen. The pressurized gas becomes compressed as the hydraulic fluid 29 enters the accumulator 42. The pressurized gas 46 facilitates urging the fluid 29 back into the housing portion 28 after a braking application has ended. In some examples, the return of the fluid 29 into the housing portion 28 is utilized to assist in accelerating the wheel of the vehicle. Such an arrangement provides a useful application of the energy generated during a braking application.

Another advantageous feature included in the illustrated example includes a plurality of fins 48 associated with the accumulator 42. The fins 48 facilitate dissipating heat from the fluid 29 within the accumulator 42. Because there tends to be heat build up during braking applications, especially in off-highway type heavy vehicles, the accumulator 42 facilitates dissipating heat from within the brake assembly in a cost-effective manner. This type of accumulator facilitates removing heated fluid from housing 28 and returning cooled fluid after a braking application.

Fluid communication between the housing portion 28 and the accumulator 42 is controlled in the illustrated example using pressure control valves 50. The illustrated example includes a controller 52 for operating the valves 50 as the illustrated valves 50 are electronically controllable. In another example, the valves 50 are mechanical valves that are timed to respond to preselected pressure levels within the housing portion 28, for example. The valves 50 facilitate controlling the amount of resistance associated with the fluid pressure within the housing portion 28 to achieve a desired braking force, for example.

As can best be appreciated from FIG. 1, another hydraulically controllable device 60 is supported on the vehicle. The accumulator 42 selectively supplies fluid 29 from the accumulator to the device 60 to provide hydraulic power to that device. The controller 52 in the illustrated example controls operation of a flow control valve 62 that regulates the flow of hydraulic fluid to the device 60. Such an arrangement provides a further avenue for utilizing the energy generated during a braking application, which is associated with the hydraulic fluid supplied to the accumulator 42. There are a variety of hydraulically activated devices that could be used as the device 60. Given this description, those skilled in the art will realize such uses for the fluid 29 from within the accumulator and be able to select appropriate components to achieve a desired result.

FIG. 3 schematically illustrates one orientation of the vanes 32 on the braking member 30. In this example, the vanes 32 are aligned in radially extending directions such that rotation of the vanes 32 about the axis 34 results in a perpendicular orientation between the movement of the vanes 32 and the corresponding flow of the fluid 29. Such an orientation provides a maximum resistance upon rotation of the braking member 30. In one example, the vanes 32 are fixed in the illustrated position on the braking member 30. As the braking member 30 is moved along the axis 34 protruding further into the fluid containing portion 28, the increased fluid pressure build up provides the desired amount of braking force.

Another example is schematically illustrated in FIG. 4. In this example, the vanes 32 are supported on the braking member 30 so that the vanes 32 are moveable into different orientations depending on the needs for particular situation. As seen in FIG. 4, the vanes 32 are oriented oblique to a radial orientation as shown in FIG. 3. If the brake member 30′ as illustrated in FIG. 4 were rotating in a counterclockwise direction, for example, the amount of resistance caused by the interaction between the vanes 32 and the fluid 29 is less than that when the vanes are in the orientation shown in FIG. 3. During a braking application, a linkage arrangement 70 preferably is actuated to move the vanes 32 from the orientation shown in FIG. 4 toward the orientation shown in FIG. 3. As schematically shown in FIG. 4, each vane 32 preferably is supported by a pivoting support member 72 so that each vane 32 is moveable relative to a remainder of the braking member 30. The vanes 32 can be associated with the linkage arrangement 70 using hinges 74.

Using an embodiment as schematically illustrated in FIG. 4 would include changing the orientation of the vanes 32 responsive to actuation of the brake pedal. An increased desired braking force (as indicated by an increased actuation of the brake pedal), would cause further movement of the vanes 32 into a position where there is an increased resistance to the continued rotation of the braking member 30′. In another example, the volume of fluid-containing space decreases with movement of the braking member 30 in addition to the movement of the vanes for increased resistance.

With selectively positionable vanes and an accumulator that returns fluid to the housing portion 28 after a braking application has been finished, the orientation of the vanes 32 may be reversed so that the fluid flow associated with the returning fluid 29 causes acceleration of the driveline components associated with the braking member 30 in a desired direction. In one example, the controller 52 is programmed to cause movement of the linkage arrangement 70 to achieve the desired orientation of the vanes 32 on the braking member 30.

There are a variety of ways to increase the fluid pressure within the housing 26 or to increase the resistance between the vanes 32 and the fluid 29 to achieve a desired braking force. Several example ways of accomplishing that have been disclosed. Modifications to the disclosed examples that come within the scope of this invention may become apparent to those skilled in the art as a result of reading this description. Such modifications or variations do not necessarily depart from the essence of this invention. The scope of legal protection given to this invention can only be determined by studying the following claims.

We claim:

1. A hydraulic vehicle braking system, comprising:
a housing;
a fluid contained at least partially within the housing; and
a braking member having a plurality of vanes oriented to extend into the fluid containing portion of the housing, the vanes moving within the housing such that the vanes interact with the fluid within the housing to provide a braking force.

2. The system of claim 1, wherein the vanes rotate about an axis responsive to rotation of a vehicle driveline component associated with the braking member and wherein the braking member moves along the axis of rotation causing increased fluid pressure within the housing during a braking application.

3. The system of claim 1, wherein the vanes move relative to the housing such that an orientation of the vanes relative to the fluid is selectively changed to alter a resistance of movement of the vanes within the fluid during a braking application.

4. The system of claim 1, wherein the housing includes a braking surface and the braking member includes at least one disc member that contacts the housing braking surface upon sufficient movement of the braking member within the housing.

5. The system of claim 4, wherein the housing braking surface and the disc member comprise a wet disc brake assembly.

6. The system of claim 1, including an accumulator coupled with the housing, at least some of the fluid being able to selectively flow between the accumulator and the housing;

7. The system of claim 6, wherein the accumulator contains a pressurized gas that is compressed when the fluid from the housing enters the accumulator, the pressurized gas operating to return at least some of the fluid to the housing responsive to decreased pressure within the fluid containing portion of the housing.

8. The system of claim 7, wherein the returned fluid operates to increase acceleration of a driveline component associated with the braking member.

9. The system of claim 6, wherein the accumulator includes a plurality of fins that are operative to dissipate heat from within the housing to cool the fluid within the accumulator.

10. The system of claim 6, wherein the accumulator selectively communicates fluid from within the accumulator to another device supported on the vehicle such that hydraulic energy associated with the fluid is provided to the device.

11. The system of claim 6, including at least one pressure valve that controls fluid flow between the housing and the accumulator responsive to the fluid pressure within the housing.

12. The system of claim 11, wherein the pressure valve is timed to permit fluid flow out of the housing only after a selected threshold fluid pressure has been exceeded within the housing.

13. A hydraulic vehicle brake system comprising:
a housing containing a hydraulic fluid;
a braking member that is moveable within the housing to increase fluid pressure in the housing to provide a braking force; and
an accumulator in fluid communication with the housing to receive at least a portion of the fluid responsive to fluid pressure increasing in the housing.

14. The system of claim 13, wherein the accumulator includes a plurality of fins that are operative to dissipate heat from within the fluid in the accumulator.

15. The system of claim 13, wherein the accumulator contains a pressurized gas and wherein the gas is compressed responsive to fluid entering the accumulator, the pressurized gas operating to cause at least some of the fluid from within the accumulator to return to the housing.

16. The system of claim 15, including a valve that controls fluid communication between the housing and the accumulator.

17. The system of claim 15, wherein the fluid returning to the housing operates to cause acceleration of a vehicle driveline component associated with the braking member.

18. The system of claim 13, including at least one other hydraulically activated device supported on the vehicle and wherein at least some of the fluid from within the accumulator is selectively supplied to the hydraulically activated device.

19. The system of claim 13, wherein the braking member includes a plurality of vanes that are supported to extend into the fluid containing portion of the housing such that the vanes rotate within the fluid and resistance associated with the vane movement in the fluid provides a braking force to cause deceleration of the braking member.

20. The system of claim 19, wherein the vanes are selectively moveable relative to another portion of the braking member to selectively vary the resistance associated with the vanes moving in the fluid.
